(19) United States
(12) Patent Application Publication
(10) Pub. No.: US 2007/0297462 A1
(43) Pub. Date: Dec. 27, 2007

(54) CASCADED CAVITY SILICON RAMAN LASER WITH ELECTRICAL MODULATION, SWITCHING, AND ACTIVE MODE LOCKING CAPABILITY

(75) Inventors: Bahram Jalali, Los Angeles, CA (US); Ozdal Boyraz, Irvine, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/677,883

(22) Filed: Feb. 22, 2007

Related U.S. Application Data
(63) Continuation of application No. PCT/US05/36435, filed on Oct. 6, 2005.
(60) Provisional application No. 60/616,740, filed on Oct. 6, 2004.
(60) Provisional application No. 60/626,901, filed on Nov. 9, 2004.

(51) Int. Cl. H01S 3/30

(52) U.S. Cl. 372/3

(57) ABSTRACT

A silicon Raman laser that can be electrically switched or modulated and which demonstrates active mode-locking capabilities. The laser can be used with a more traditional glass fiber cavity, or can be fabricated on a single chip with a cavity, or a cascaded cavity, in which the chip fabrication is compatible with widely used silicon chip fabrication methods. The laser can be tuned by adjusting a source pump laser to produce specific output and operates at room temperature. Output is present in the near- and mid-infrared frequency range, and the laser can simultaneously produce output at the Stokes and at the anti-Stokes wavelengths.

### CROSS-REFERENCE TO RELATED APPLICATIONS

This application claims priority from, and is a 35 U.S.C. §111(a) continuation of, co-pending PCT international application serial number PCT/US2005/036435, filed on Oct. 6, 2005, incorporated herein by reference in its entirety, which claims priority to U.S. provisional application Ser. No. 60/616,740, filed on Oct. 6, 2004, incorporated herein by reference in its entirety, and to U.S. provisional application Ser. No. 60/626,901, filed on Nov. 9, 2004, incorporated herein by reference in its entirety.

### STATEMENT REGARDING FEDERALLY SPONSORED RESEARCH OR DEVELOPMENT

This invention was made with Government support under Grant No. F49620-02-1-0417, awarded by the Defense Advanced Research Projects Agency. The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to silicon Raman lasers, and, more particularly, to a chip-scale Raman laser made of silicon that is switched or modulated electrically and has mode-locking capabilities.

2. Description of Related Art

The need for low cost photonic devices has stimulated a significant amount of research in silicon photonics. While a wide variety of passive devices were developed in the 1990's, recent activities have focused on achieving active functionality, mostly light amplification and generation, in silicon waveguides. One approach that has been investigated for light generation and amplification is the Raman effect. This approach relies on the fact that the Raman gain coefficient in silicon is rather strong (up to 10⁴ times higher than in fiber), making it possible to achieve gain over the length scales of an integrated waveguide. The Raman approach is particularly important, because it can produce radiation in the mid-IR spectrum, where there is utility in various medical and defense applications.

Several laser applications utilizing the Raman effect have been developed:

Fiber Raman lasers are large table top devices, requiring several kilometers of fiber. Short pulse operation of such lasers, therefore, is difficult to realize, due to the walk-off of the pump and the Stokes pulse over this length. Also, because the fiber is made of glass, an insulating material, it is not possible to fabricate transistors or diodes. Finally, these lasers do not have the capability for switching or modulation, other than switching or modulating the pump laser itself.

The micro-cavity Raman laser, described in U.S. Published Application No. 2003/0021301, incorporated herein by reference in its entirety, suffers from similar problems. The use of glass in this type of laser subjects it to the same limitations in the fabrication of transistors or diodes. It is also not possible to control the laser dynamics using current injection directly into the laser cavity. Additionally, from a material point of view, these lasers are not process compatible with silicon technology. The processes used in their fabrication are not standard in silicon chip manufacturing.

GaP Raman lasers use GaP, which is an expensive material. Electrical control of the GaP Raman laser is not currently known, and GaP is not compatible with silicon manufacturing.

Cascaded cavity fiber Raman lasers currently use silica (SiO₂) as an active material, which has a much lower Raman gain coefficient than silicon (Si) necessitating approximately a kilometer of fiber to achieve lasing. Silica also has large optical losses in the mid-infrared range at wavelengths larger than approximately 2 microns. Therefore, it cannot be used as the waveguide material, as it is used in near IR applications.

Although semiconductor injection lasers do not make use of the Raman effect, they are important in the world of lasers. However, they require unavailable or expensive exotic materials for operation in the mid-IR region, and often require cryogenic cooling to avoid thermal effects.

Known methods of active mode locking of lasers are described with reference to actively modelocked Erbium doped fiber lasers by Pritel (www.pritel.biz) or Calmar (www.calmaropt.com), each incorporated herein by reference in its entirety.

### BRIEF SUMMARY OF THE INVENTION

The present invention is a silicon Raman laser that can utilize a cascaded cavity (nested cavity configuration), can be electronically modulated or switched, and can be mode-locked. The silicon Raman laser is coupled to a pump laser, and its output is adjustable to the extent that the pump laser is adjustable.

According to one aspect of the invention, an apparatus is provided that comprises a silicon gain medium, a cavity resonator proximate to said silicon gain medium, and means to couple the silicon gain medium to a pump laser. In one embodiment, output from the apparatus is in the mid-infrared part of the spectrum. In another embodiment, output of the apparatus is controlled by injecting current into the silicon gain medium or the cavity resonator. In another embodiment, the apparatus is fabricated on a single chip. Another embodiment comprises means for electrical switching or modulation of the apparatus. Another embodiment comprises means for active mode locking of the apparatus. Still another embodiment comprises means to tune the pump laser, wherein output from the apparatus is dependent on adjustment of the means to tune the pump laser. In another embodiment, the apparatus is a functional component of a device from the group consisting of: biochemical sensor systems, infrared countermeasures systems, or free space optical communications systems. In yet another embodiment, the apparatus is a functional component of a medical, dental, or industrial device that exploits the strong laser-tissue interaction at a wavelength of 2.9 microns.

According to another aspect of the invention, an apparatus is provided that is a monolithic silicon Raman laser that comprises an on-chip cavity. In one embodiment, the on-chip cavity has a nested cavity configuration.

According to another aspect of the invention, an apparatus is provided that comprises a silicon Raman gain medium and a cavity proximate to the silicon gain medium, wherein said cavity has a nested cavity configuration, and wherein said cavity has multiple resonance frequencies that match multiple Stokes orders of Raman scattering. In one embodiment, output from the apparatus is in the mid-infrared part of the spectrum. In another embodiment, output of the apparatus is controlled by injecting current into the silicon gain medium or the cavity resonator. In another embodiment, the apparatus is fabricated on a single chip. Another embodiment comprises means for electrical switching or modulation of the apparatus. Another embodiment comprises means for active mode locking of the apparatus. Still another embodiment comprises means to couple the silicon gain medium to a pump laser and means to tune the pump laser, wherein output from the apparatus is dependent on adjustment of the means to tune the pump laser. In another embodiment, the apparatus is a functional component of a device from the group consisting of: biochemical sensor systems, infrared countermeasures systems, or free space optical communications systems. In yet another embodiment, the apparatus is a functional component of a medical, dental, or industrial device that exploits the strong laser-tissue interaction at a wavelength of 2.9 microns.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of an embodiment of a silicon Raman laser.

FIG. 2 is a diagram of the simplest embodiment of a monolithic laser cavity according to the present invention.

FIG. 3 is a depiction of a micro-ring nested cavity silicon Raman laser.

FIG. 4 is a graph of measured on-off gain in the silicon waveguide.

FIG. 5 is a diagram of the experimental setup used for Example 1.

FIG. 6 is a graph of the measured laser output power with respect to peak pump power.

FIG. 7A shows the measured spectrum of the silicon Raman laser operating in the pulsed mode.

FIG. 7B shows the measured spectrum of the pulsed pump laser.

FIG. 8A shows the measured temporal profile of the silicon Raman laser output at the Stokes wavelength of 1675 nm.

FIG. 8B shows the output pulse train at 25 MHz of the silicon Raman laser.

FIG. 9 is a diagram of the experimental setup used for Example 2.

FIG. 10 shows the measured laser output power variation with respect to average pump power.

FIG. 11 shows the variation in the measured anti-Stokes power with respect to the average pump power.

FIG. 12A shows the measured spectrum of the silicon Raman laser.

FIG. 12B shows the measured spectrum of the anti-Stokes signal.

FIG. 13 is a diagram of the experimental setup used for Example 3.

FIG. 14 is a diagram of the waveguide and p-n junction diode.

FIG. 15 is a graph of the input-output characteristics of the silicon Raman laser.

FIG. 16 shows the measured coherent anti-Stokes emission.

FIG. 17 shows the switching characteristics of the laser when a digital electrical waveform is applied to the diode.

FIG. 18 shows the electronic modulation results for the silicon Raman laser.

### DETAILED DESCRIPTION OF THE INVENTION

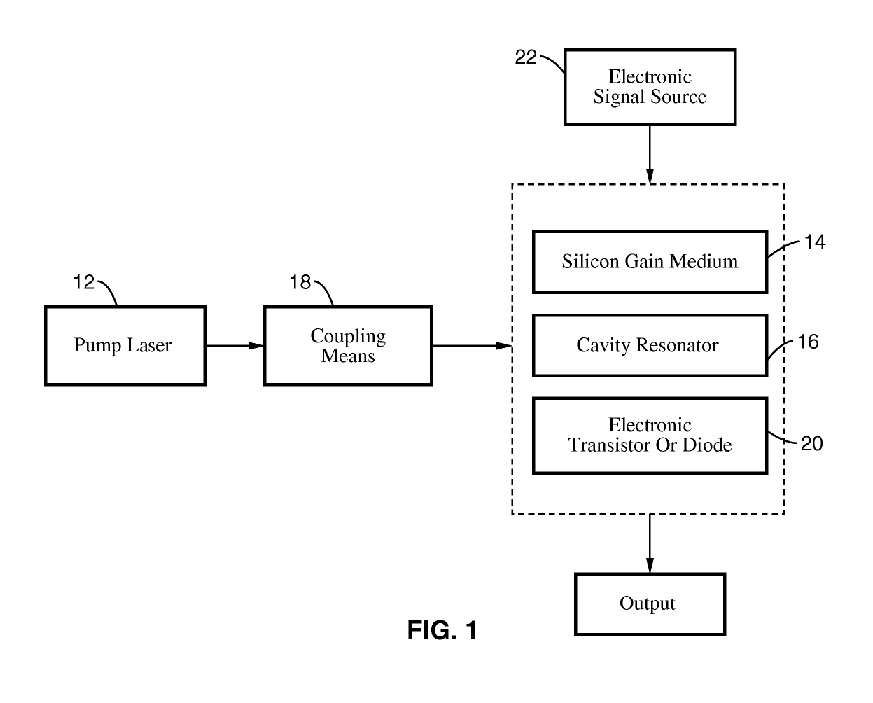

Referring more specifically to the drawings, for illustrative purposes the present invention is embodied in the apparatus generally shown in FIG. 1 through FIG. 18. It will be appreciated that the apparatus may vary as to configuration and as to details of the parts, and that the method may vary as to the specific steps and sequence, without departing from the basic concepts as disclosed herein.

The present invention is a silicon Raman laser that produces light in the mid infrared (MIR) portion of the spectrum. This is achieved by incorporating a silicon Raman gain medium in a cascaded cavity, also known as a nested cavity configuration. See Examples 1-3. Lasing then occurs at a high order Raman peak that can readily extend into the MIR spectrum. The cavity can be external (for example, using optical fibers) or internal, using micro disk/ring resonators, Fabry-Perot cavity or a combination. Such devices would be much smaller than fiber Raman lasers.

Referring to FIG. 1, one embodiment of the present invention includes means to control a silicon Raman laser using electronic signals and integrated with electronic circuitry on a single silicon chip. It also permits active mode locking of the laser. The device includes a pump laser 12, a silicon gain medium 14, a cavity resonator 16, a means to couple the pump laser to the silicon device 18, an electronic diode or transistor 20 that controls the laser output by injecting current into the laser gain medium or cavity, and an electronic signal source 22. This device does not exhibit thermal effects and thus operates at room temperature.

By exploiting silicon's very high gain coefficient, a highly compact, chip-scale device can be realized. The silicon device can operate in pulsed mode, unlike fiber devices. Silicon devices exploit silicon's high thermal conductivity and high optical damage threshold, features that are very important in such lasers. The present invention provides an inexpensive and compact source of near and mid-IR radiation.

The next step in silicon Raman lasers is to control the modulation, switching and active mode locking of the laser. A unique advantage of the silicon Raman laser, compared to the fiber Raman laser, is internal electronic modulation capability, which facilitates integration with on-chip electronics.

A typical laser includes an optical gain element placed inside a resonant cavity. In the case of a Raman laser, atomic vibrations provide energy transfer from the pump to a new wave (Stokes wave). Lasing at the Stokes wavelength occurs when the amplification per round trip exceeds the loss per round trip. The output of the laser can be switched or modulated electronically if the intra-cavity loss can be altered. The optical loss in silicon is a linear function of free carrier (electrons and holes) density and this can be altered by many orders using a diode. This offers a unique ability to electronically switch the silicon laser output using a diode laser cavity. This is where a semiconductor (silicon) Raman laser has a unique advantage over conventional counterparts that are made from insulators (silica) to achieve on-chip lasing and switching. The free carrier effect has previously been used to create silicon light valves to modulate the light generated by non-silicon lasers. The silicon device achieves digital control of intra-cavity gain using a diode laser cavity. In contrast to the traditional Raman lasers, this embodiment of the present invention can be directly modulated to transmit data, and can be part of a silicon optoelectronic integrated circuit.

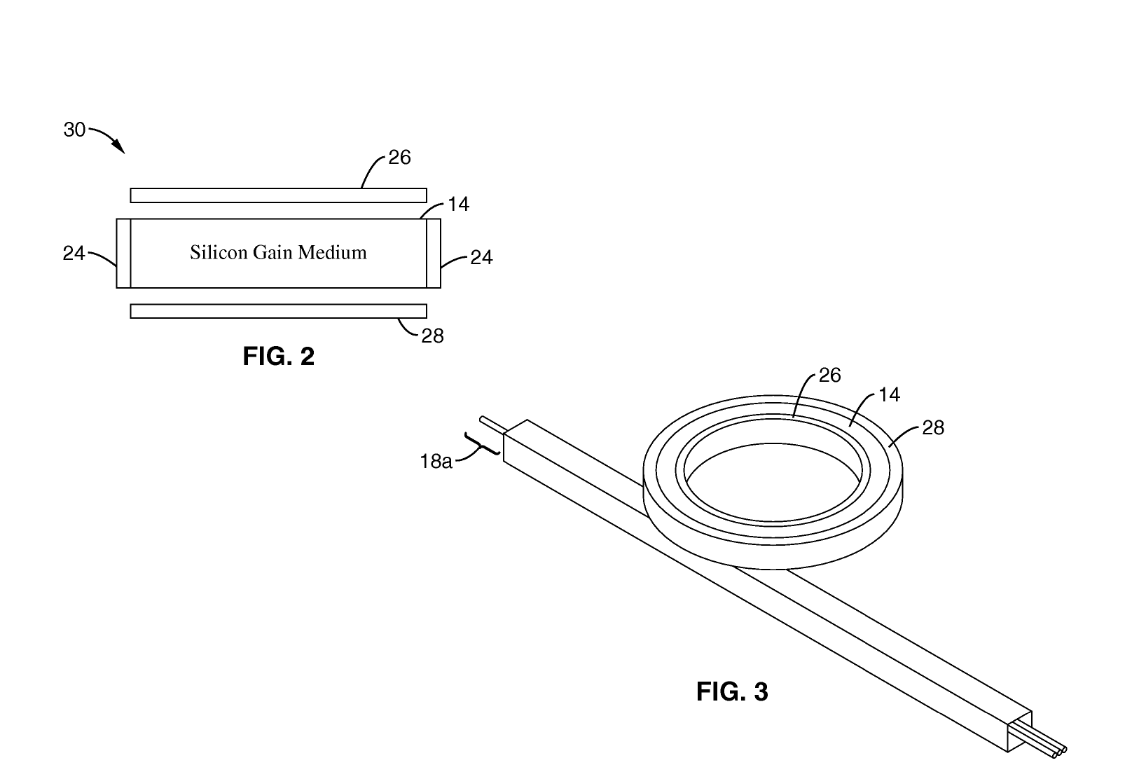

In another embodiment, the most compact solution is realized when the laser gain medium, the laser cavity (including the cascaded cavities) and the electronic driver (diode or transistor) are fabricated on the same chip. The pump laser can be external or can be integrated using flip chip bonding or wire bonding on the same substrate as the silicon Raman laser. Referring now to FIG. 2, the simplest embodiment of a monolithic laser cavity is depicted, in which a silicon gain medium 14 is bounded on each end by a dielectric mirror 24. P+ electrodes 26 and N+ electrodes 28 surround the remaining free ends of the silicon gain medium 14 to complete the cavity 30 itself. FIG. 3 depicts a micro-ring nested cavity silicon laser. The innermost and outermost concentric rings of the cavity 30 are the P+ electrodes 26 and N+ electrodes 28. For the embodiment shown in FIG. 3, the pump laser (not shown) is introduced on the coupling 18a, shown on the left side.

To maximize the coupling of the pump laser to the silicon waveguide or resonator gain medium, a waveguide taper is preferred. For efficient modulation, there needs to be a large amount of overlap between the optical mode and the injected free carriers. Also, the current injection path must have low resistance to avoid unnecessary voltage drop and unwanted heating. A transistor offers current or voltage gain, compared to a diode. For example, if a bipolar transistor (BJT or HBT) is used in the common emitter configuration, a small amount of current applied to the base can control a much larger current, produced at the collector terminal, that can modulate or switch the laser. Another important consideration is the dependence of two photon absorption on wavelength. When the photon energy falls below 50% of the energy bandgap in silicon (energy bandgap≈1.1 eV at room temperature) two photon absorption diminishes, alleviating the free carrier absorption problem.

The present invention exploits stimulated Raman scattering in silicon to generate coherent radiation at the fundamental or higher order Stokes peaks. When pumped with a laser at a given wavelength, it lases at longer wavelengths that are downshifted from the pump by multiples of optical phonon frequency in silicon (approximately 15 THz). The lasing wavelength “tracks” the pump wavelength; hence, the lasing wavelength can be tuned by changing the wavelength of the pump laser. It may also be possible to “force” the device into lasing at the anti-Stokes wavelength, which is upshifted from the pump by the optical phonon frequency. This will require phase matching between the pump, Stokes and anti-Stokes waves.

Diodes fabricated on the same chip as the laser control the free carrier density inside the laser cavity and, consequently, the cavity loss. This can be achieved by (1) carrier injection using a forward bias diode or using a transistor, or through (2) carrier depletion using a reverse bias diode. The electrical switching of the laser output is demonstrated in Example 3.

In another embodiment, the ability to actively control the loss inside the laser cavity can be used to mode lock the laser. In this mode, the laser operating in continuous mode will produce pulses that are synchronized to an external pulse or sinusoidal waveform. The mode can be at the fundamental or the harmonic. In the former, the repetition period of the output pulses is the same as the cavity round trip. In other words, the repetition frequency is the same as the fundamental resonant frequency of the cavity. In harmonic mode locking, the repetition rate is an integer multiple of the fundamental resonant frequency of the cavity.

The laser can operate in wavelength range of ≧1.2 microns. One challenge with continuous (as opposed to pulsed) operation of the laser is the absorption by free carrier generated by two photon absorption. Carrier depletion using a reverse bias junction can be used to alleviate this problem. At wavelengths larger than approximately 2.3 microns, the two photon absorption subsides, which diminishes the free carrier effect. Thus, the laser of the present invention is particularly suited for operation at mid-infrared wavelengths.

### EXAMPLE 1

### Silicon Raman Laser

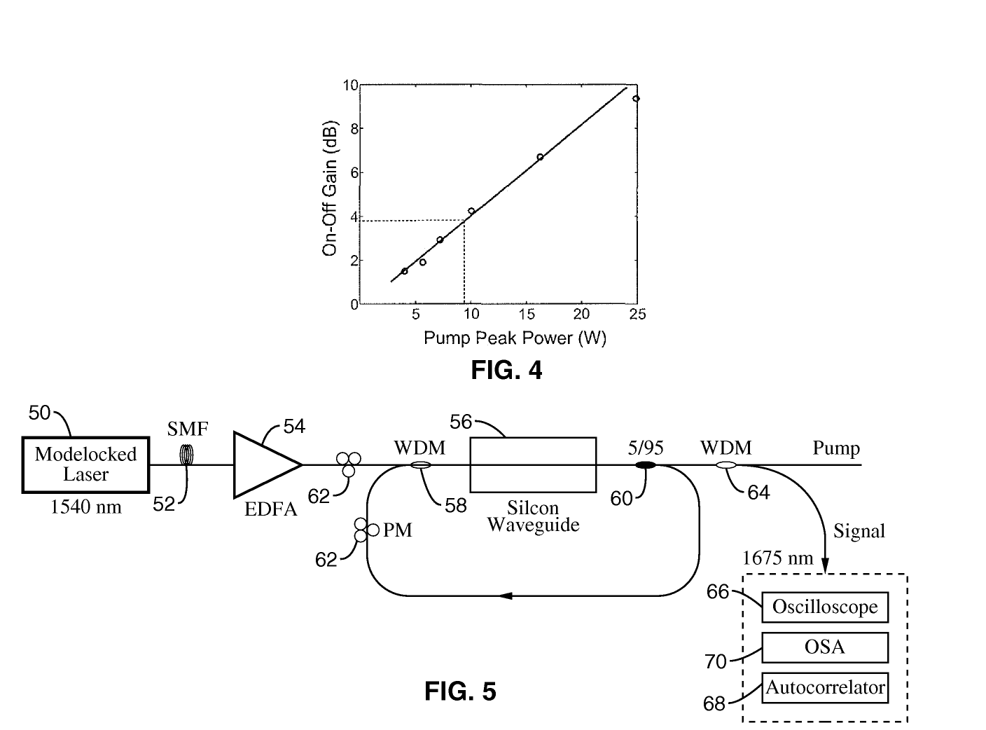

A modelocked fiber laser 50 operating around 1540 nm with a 25 MHz repetition rate is used as a pulsed pump laser. In the present experiment, to prevent excessive spectral broadening and the pulse distortion in the amplifier and in the fiber patchcords, the pulses are broadened to 30 ps in a spool of fiber 52 before amplification using an erbium doped fiber amplifier (EDFA) 54 to the desired peak power. A tapered Silicon-On-Insulator (SOI) rib waveguide 56 approximately 2 cm in length and with a total insertion loss (coupling plus propagation) of 0.8 dB, is used as a gain medium. We first characterize the Raman gain in the silicon waveguide 56, using a CW laser at 1675 nm (Stokes wavelength) as the probe signal. Gain is measured by observing the enhancement of the probe signal in the presence of the pump pulse. The results, shown in FIG. 4, indicate that the silicon waveguide provides up to 9 dB of on-off gain at 25 W of peak pump power.

The setup for demonstration of the silicon Raman laser is shown in FIG. 5. In this case, no probe signal is used. Pump pulses are coupled into the laser cavity by using a Wavelength Division Multiplexer (WDM) coupler 58. The laser cavity is formed using a fiber ring configuration. Following the silicon waveguide 56, a tap coupler 60 with 5 to 95% splitting ratio is used to extract 5% of the power as the output. The 95% output of the tap coupler 60 is looped back into the WDM coupler 58 to form the ring cavity. Residual pump power is blocked by the WDM coupler. By measuring the propagation time of the modulated 1675 nm CW laser, the cavity round trip time is measured and the cavity length (˜8 m) is adjusted such that the cavity roundtrip time will match the pump pulse period of 40 ns. Two Polarization Controllers (PC) 62 are inserted on the pump arm and in the cavity to adjust the relative polarizations of the pump and the laser. The pump polarization is set to TE polarization to obtain maximum coupling. The polarization state of the Stokes is adjusted for maximum output power. The total cavity loss, including the silicon waveguide 56, measured at the Stokes wavelength (1675 nm) is measured to be 3.7 dB. A second WDM 64 is used at the laser output to separate the pump and signal wavelengths. The temporal characteristics of the laser are measured by a 40 GHz sampling oscilloscope 66, and separately with an autocorrelator 68. An Optical Spectrum Analyzer (OSA) 70 is used to measure the spectrum.

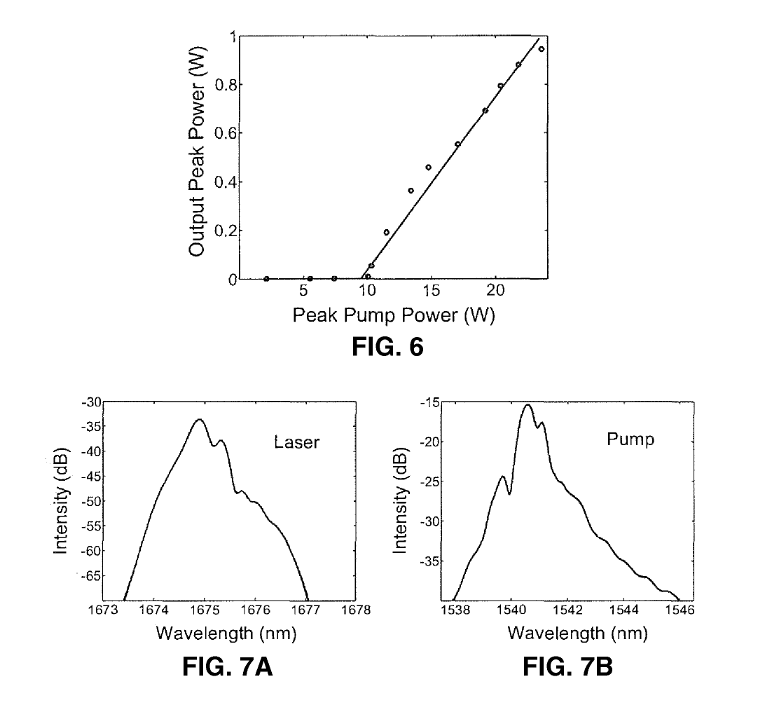

The measured laser output power variation with respect to pump peak power is illustrated in FIG. 6. The peak pump power is varied from 0 to 25 W to characterize the lasing behavior and to determine the lasing threshold. Lasing, characterized by a sudden increase in emission at the Stokes wavelength of 1675 nm, is obtained when the pump peak power level reaches 9 W. The threshold should occur when the waveguide gain compensates for the cavity loss. The threshold power of 9 W is consistent with the measured cavity loss of 3.7 dB and the measured Raman gain of ˜3.9 dB at 9 W pump power (FIG. 4). After exceeding the threshold level, the output increases almost linearly with the pump power. The slope efficiency, which is described by the ratio of the output peak power and the input peak pump power, is 8.5%.

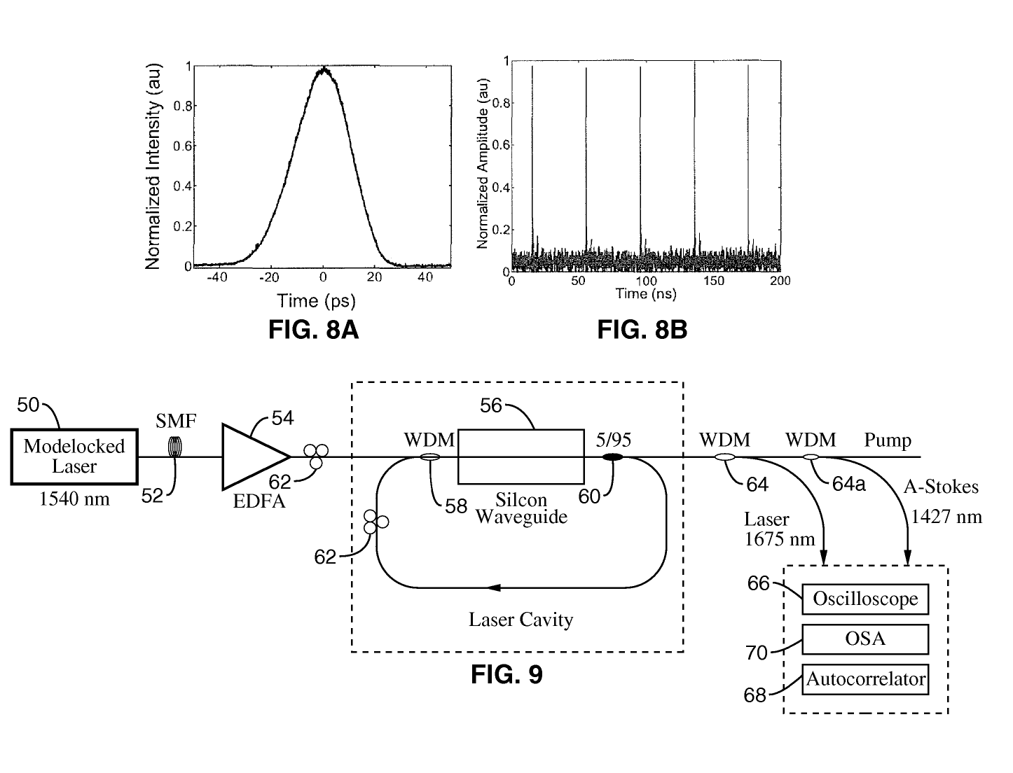

The measured laser spectrum is presented in FIG. 7A, and that of the pump is presented in FIG. 7B. The spectral peak of the silicon Raman laser is at 1675 nm, which is precisely the expected location based on the optical phonon frequency (15.6 THz) in silicon. The 3 dB bandwidth of the laser is measured to be 0.36 nm (˜38.5 GHz). The pump laser, on the other hand, is centered at 1540 nm with a 3 dB bandwidth of 0.7 nm (˜88.5 GHz). The narrower laser bandwidth can be explained by the gain narrowing, a well-known behavior in lasers. The spectral features and the asymmetric structure of the laser spectrum are similar to the spectral features of the pump laser shown in FIG. 7B. Raman scattering is a resonant phenomenon with an intrinsic bandwidth (FWHM) of ˜100 GHz. FIG. 8A shows the measured temporal profile of the laser output at the Stokes wavelength of 1675 nm, measured using an autocorrelator. The pulse width at FWHM in this measurement is 25 ps. The actual pulse width is calculated to be 17.7 ps, based on the Gaussian approximation. By using the measured 0.36 nm spectral bandwidth, the time bandwidth product (Δτ.Δυ) of the laser is calculated to be 0.68 and it is not transform limited. This conclusion will not materially change if we assume Sech pulse shapes. The walkoff between pump and the laser in the gain medium and the complex spectral shape of the pump laser are believed to be main reasons for non-transform limited pulses. FIG. 8B shows the output pulse train at 25 MHz, measured using a 40 GHz oscilloscope. The small features 4.2 ns after the pulses are caused by the ringing in the photodetector circuitry.

A comment must be made regarding the role of the Raman interaction in the fiber that constitutes the laser cavity. The Raman effect in fibers has a broadband gain spectrum (>10 THz) with a primary peak located at 13.2 THz downshifted from the pump, and a secondary peak at 14.7 THz. These correspond to wavelengths of 1652 nm and 1666 nm for our pump wavelength of 1540 nm. In contrast, the peak of the narrow gain spectrum of silicon, and the observed emission (FIG. 7A) lies at 1675 nm. At this point in the gain spectrum of fiber, the gain coefficient is reduced to approximately 30% of its peak value. Furthermore, the measured peak gain coefficient in fiber is 1×10⁻¹³ m/W for 1 μm pump wavelength. Assuming a linear dependence on pump wavelength and using the known gain spectrum of fiber, we obtain a peak gain coefficient of gR=0.7×10⁻¹³ m/W at 14.7 THz away from the pump wavelength of 1540 nm. With the known effective area of 80 μm² for single mode fiber, the total gain in the fiber for 10 W pump power is calculated to be 0.31 dB. This gain will be far less than the cavity loss of 3.7 dB and hence insufficient to cause lasing. When considering that the observed peak emission occurs 15.6 THz away, the Raman gain coefficient in fiber would be 0.3×10⁻¹³ m/W corresponding to a total gain of 0.13 dB.

### EXAMPLE 2

### Stokes and Anti-Stokes Emission

FIG. 9 shows the block diagram of the silicon Raman laser as utilized. A modelocked fiber laser 50 operating at 1540 nm with 25 MHz repetition rate is used as a pulsed pump laser. After broadening the laser pulse width to 30 ps in a spool of standard Single Mode Fiber (SMF) 52 and amplification using an EDFA 54, the pump pulses are coupled into the laser cavity by a Wavelength Division Multiplexer (WDM) coupler 58. The output of the WDM is coupled to the silicon waveguide 56, which provides the optical gain. The waveguide 56 is approximately 2 cm long with measured 0.8 dB fiber-to-fiber insertion loss. At the waveguide output, a tap coupler 60 directs 95% of the power back to the input WDM coupler 58 to form a laser ring cavity. Two Polarization Controllers (PC) 62 are inserted, one on the pump arm and one in the cavity, to adjust the relative polarizations of the pump and the laser. The total length of the cavity is ˜8 m and adjusted to obtain 40 ns delay (the same as the pump period) at 1675 nm. The total cavity loss at 1675 nm is measured to be around 3.7 dB by using a CW signal at that wavelength. The 5% of the waveguide output is used to monitor the output. First, the laser output at 1675 nm is separated from the pump and the anti-Stokes using a WDM coupler 64. Then, another WDM coupler 64a is used to extract the anti-Stokes wave. The temporal characteristics of the laser are measured with a 40 GHz oscilloscope 66 and also with an autocorrelator 68. An Optical Spectrum Analyzer (OSA) 70 is used to measure the spectrum.

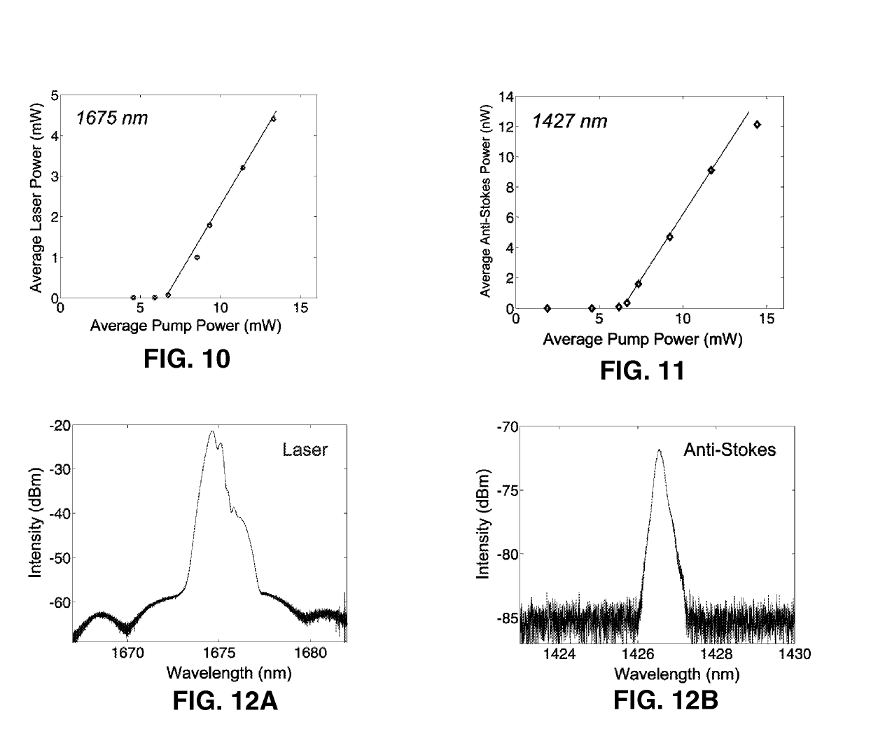

The measured laser output power variation with respect to average pump power is illustrated in FIG. 10. The average pump power is varied from 0 to 15 mW to characterize the lasing behavior and to determine the lasing threshold. As shown in FIG. 10, lasing, characterized by a sudden increase in emission at the Stokes wavelength of 1675 nm, is obtained when the average pump power level reaches to ˜7 mW, which corresponds to the peak power level of 9 W. The threshold should occur when the waveguide gain compensates for the cavity loss. This value is consistent with the measured cavity loss of 3.7 dB and the measured Raman gain of ˜3.9 dB at 9 W pump power. After exceeding the threshold level, the output increases almost linearly with the pump power. It can readily be shown that lasing is caused by the Raman effect in silicon and not by the fibers, due to the fact that the Raman gain coefficient in silicon is 10⁴ times higher than in fiber. At the threshold, the Raman gain in the 8 meters of fiber is <0.2 dB, which is negligible compared to the measured open loop gain of 3.9 dB in silicon. Also, the spectral position of the laser output matches the Stokes wavelength of silicon, but does not match the Raman gain peak in the fiber.

In stimulated Raman scattering, Stokes and anti-Stokes fields are simultaneously generated with the Stokes field experiencing amplification and exponential growth along the waveguide length. However, the extent to which the anti-Stokes is emitted depends on the phase mismatch between the pump (k_{P}), Stokes (k_{S}) and anti-Stokes (k_{A}) fields, described by the relation Δk=2 k_{P}−k_{S}−k_{A}. As Δk tends to zero, the three fields experience strong parametric coupling, leading to the exchange of information between the Stokes and anti-Stokes channels. In this regime, the Raman nonlinearities can be used to perform wavelength conversion across widely spaced channels. This process has been used to demonstrate data conversion between the 1500 nm and 1300 nm bands. In silicon, this process is more efficient than four wave mixing based on the electronic susceptibility, because the Raman susceptibility χ_{R}⁽³⁾=11.2×10⁻¹⁴ cm²/V²) is ˜44 times larger than the electronic counterpart (χ_{E}⁽³⁾=0.25×10⁻¹⁴ cm²/V²). However, the Raman process, being resonant, has a characteristic Lorentzian gain profile (bandwidth ˜105 GHz in silicon), which determines the response of the conversion process to wavelength detuning from the peak.

FIG. 11 illustrates the variation in the measure anti-Stokes power with respect to the average pump power. When the pump power reaches the lasing threshold level of 7 mW, anti-Stokes wavelength is observed. The cavity is designed for lasing at 1675 nm, and additionally, the circulation of anti-Stokes is blocked by the WDM coupler. Therefore, the system is not lasing at the anti-Stokes wavelength. Rather, the signal is due to parametric coupling between the lasing (Stokes) pump and anti-Stokes waves. This explains the much lower power levels at the anti-Stokes wavelength compared to the Stokes wavelength.

The measured laser spectrum is presented in FIG. 12A, and that of the anti-Stokes signal is presented in FIG. 12B. The spectral peak of the silicon Raman laser is at the Stokes wavelength of 1675 nm, which is precisely the expected location based on the optical phonon frequency in silicon (15.6 THz). The 3 dB bandwidth of the laser is measured to be 0.36 nm (˜38.5 GHz). The anti-Stokes laser, on the other hand is centered at 1427 nm, which is 15.6 THz upshifted from the pump wavelength. The frequency difference between the laser and the anti-Stokes is measured to be 31.2 THz, which is precisely twice the optical phonon frequency in silicon.

### EXAMPLE 3

### Direct Electrical Modulation

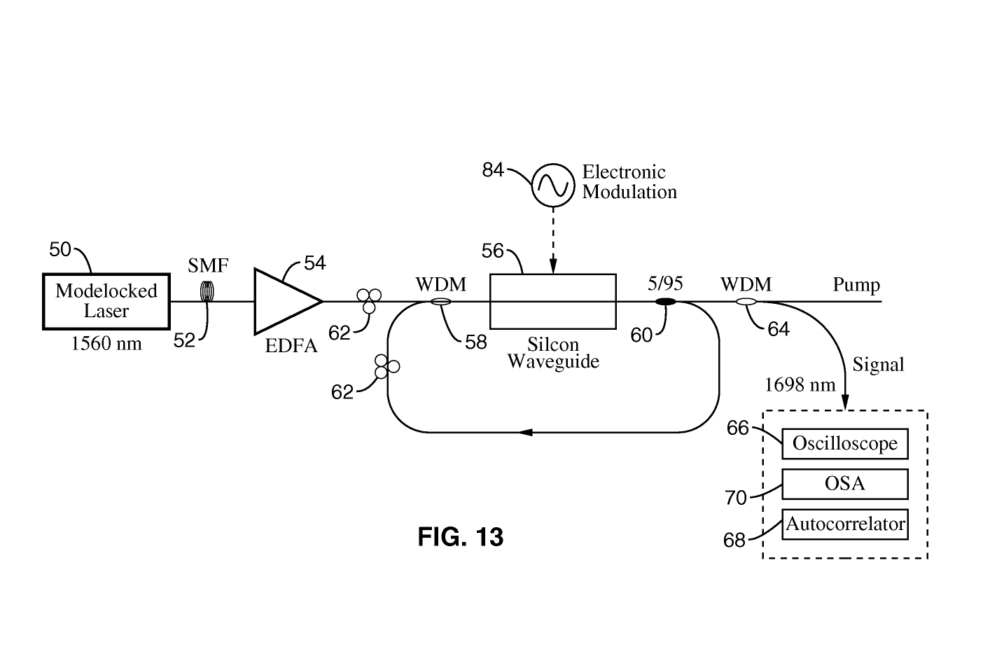

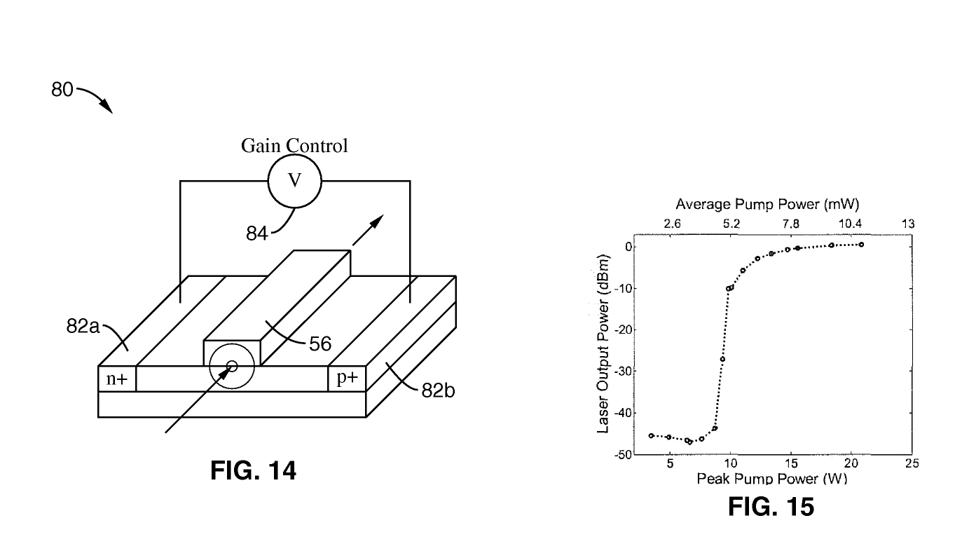

A laser was constructed using a silicon chip and a fiber loop cavity as illustrated in FIG. 13. The chip contains a waveguide 56 plus a p-n junction diode 80 (FIG. 14). The p-n junctions 82a, 82b are 8 μm away from the edge of the rib waveguide 56 and they do not induce additional propagation loss due to this large gap. The waveguide 56 is 2 cm long, has input and output tapers, and has a total insertion loss of 1 dB. The modal area is approximately 5 μm². We used 30 ps pump pulses at 20 MHz repetition rate and at a wavelength of 1560 nm. These were generated by broadening 1 ps pulses generated by a Calmar Optocom modelocked fiber laser 50 in a piece of standard single mode fiber 52. The laser cavity is formed using a fiber ring configuration. Following the silicon waveguide 56, a tap coupler 60 with 5 to 95% splitting ratio is used to extract 5% of the power as the output. The 95% output of the tap coupler 60 is looped back into the WDM coupler 58 to form the ring cavity for Stokes wavelength while blocking the residual pump wave. The length of the fiber was chosen such that the cavity roundtrip time equals the pump pulse period. The relative polarization of the pump and Stokes were adjusted for maximum efficiency using two polarization controllers 62. The total cavity loss, including the silicon waveguide 56, measured at the Stokes wavelength (1675 nm), is measured to be 3.7 dB. At the output port, a second WDM coupler 64 is used to separate the pump and signal wavelengths. To switch the laser on and off, a function generator 84 is connected to the diode laser cavity. A sampling oscilloscope 66, an autocorrelator 68, and an Optical Spectrum Analyzer (OSA) 70 are used to measure the output characteristics of the laser.

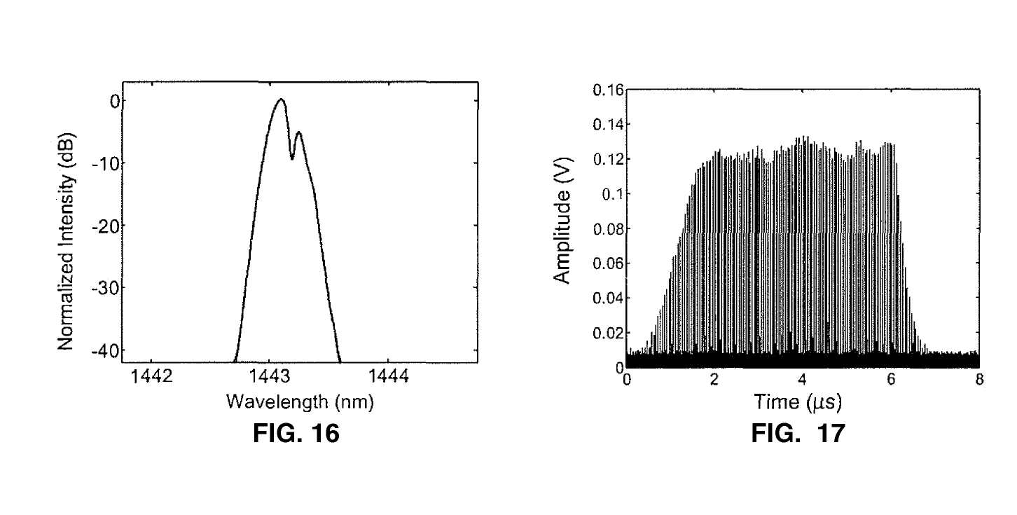

The observed threshold characteristics of the laser are shown in FIG. 15. Data is plotted in logarithmic scale to show the near threshold behavior with more clarity. The lower abscissa shows the peak power of pump pulses while the upper abscissa displays the average pump power. Below threshold, the output power is around −40 dBm level and is limited by the noise floor of the optical spectrum analyzer used in the experiment. Once the lasing threshold is reached, there is a sudden 1000-fold (30 dB) increase in the output power. Above the threshold, the output power increases linearly, as expected, and a high peak output power of 2.5 W is obtained when the peak pump power is 20 W. The slope efficiency, defined here as the ratio of peak output power to peak pump power, is calculated to be 12.5%. Broadening of pump pulses due to self phase modulation was evident at high powers and can also account for the observed saturation behavior. Coherent Anti-Stokes Raman Scattering (CARS) was also measured in our experiment. See FIG. 16. The peak emission was at a wavelength of 1443 nm, which corresponds to the pump frequency after it is up-converted by the 15.6 THz optical phonon frequency of silicon. Since the CARS generation depends on the presence of Stokes frequency, the anti-Stokes frequency will be turned off when the laser is switched off. Thus, dual wavelength lasing with simultaneous switching can be possible in silicon. The laser presented here is modelocked; the CARS line width is >20 GHz and the laser linewidth is ˜40 GHz, which are broader than a typical CW laser as expected. The amplitude of the anti-Stokes wave was approximately ˜10⁻⁵ times lower than the Stokes wave. The efficiency of the CARS process depends on phase matching and drops sharply away from the phase matched condition. This explains the low anti-Stokes conversion efficiency, as no attempt was made to affect phase matching in the silicon waveguide.

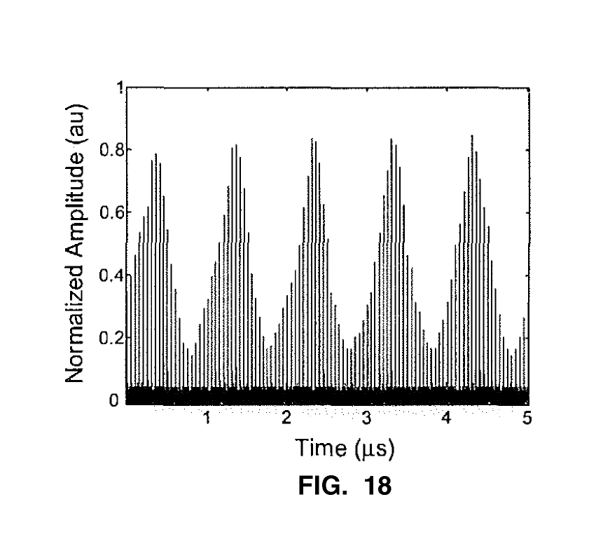

A key attribute of the silicon Raman laser is its electronic modulation capability. Optical loss in silicon and hence the net optical gain in the laser cavity is proportional to the free carrier density in silicon, with a dependence that is described as: Δα=1.7×10⁻¹⁷·ΔN, where Δα is the change in loss caused by ΔN change in free carrier density. The linear dependence of free carrier density on diode forward current provides direct electronic modulation of the intra-cavity gain. The laser will be turned off when the loss induced by diode current exceeds the gain per round trip in the cavity. Hence, the device will function as a “normally on” switch that is turned off when forward bias is applied to the p-n junction diode. FIG. 17 shows the switching characteristics of the laser when a digital electrical waveform with 2.5 mA peak current and 200 ps rise/fall time is applied to the diode. The output pulse train of the laser is switched on and off as expected, with a measured turn-on time of 1 μs and a turn-off time of 500 ns. The turn-off time will depend on the rate of carrier injection and hence on the switching time of the diode, whereas the turn-on time will depend on the photon lifetime in the laser cavity. For a ring laser cavity, the roundtrip time is defined by c/(n·l), where c is the speed of light, n is the refractive index and l is the cavity length. Because of the 5% coupler use to extract the output from the cavity, we expect the photon lifetime to be 20 times the cavity roundtrip time, which corresponds to a value of 20×50 ns=1 μs. FIG. 18 shows the laser output with 1 MHz modulation applied to the p-n junction diode. While the modulation speed is limited in these experiments, the results clearly demonstrate the electronic switching feature of the silicon Raman laser.

The use of a monolithic silicon micro-cavity bodes well for high speed switching of the laser, since both the rise and fall times scale with the cavity size. Passive silicon micro disk and micro ring cavities have been demonstrated and represent the natural evolution of the silicon Raman laser. As an example, a micro ring with circumference of 1 mm results in a roundtrip time of 10 ps, or an equivalent turn-on time of 200 ps. This assumes that the diode's current can be switched within this time scale. Because of its capacitance scale with device dimensions, the electrical switching time of the diode will also scale with device dimensions, a fortuitous trend as it relates to high speed performance. Using MOS structure as it is reported in silicon modulators can, in principle, also be used to improve the switching speed of the laser. Moreover, the index change due to free carrier injection will alter the effective cavity length and hence the resonance frequency of the micro cavity resonators and result in faster switching speeds. Switching time of the diode can be further increased by operation in the depletion mode as opposed to the injection mode. Depleting the gain medium will also enable Continuous Wave (CW) operation of the laser. In the present experiment, the laser was operating in the pulsed mode in order to mitigate losses associated with free carriers that are generated by two photon absorption. CW operation can be achieved by using p-n junction to deplete such carriers. While the present device is not optimized for this function, preventing the laser from CW operation, an optimized version can attain electronically switched CW operation. In this configuration the diode will operate in depletion mode and the laser would be a “normally switched off” switch.

The present invention provides an inexpensive and compact source of near and mid IR radiation. It has important applications in spectroscopy and sensing. In particular, its unique ability to operate in pulsed mode enables time resolved spectroscopy. Another application is in IR Counter Measure (IRCM), where a mid-IR source is used to jam heat seeking missiles. Another application is free space optical communication, which can benefit from operation in mid-IR wavelengths where attenuation in air/fog is low. The laser can also enable new medical applications as a source for coherent radiation at 2.9 micron wavelength. For example, taking advantage of the strong absorption of water at 2.9 micron wavelength, a number of medical, dental, and industrial applications can be devised that exploit the strong laser-tissue interaction at this wavelength.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A silicon Raman laser, comprising:
a silicon gain medium;
a cavity resonator proximate said silicon gain medium; and
means to couple said silicon gain medium to a pump laser.

2. A silicon Raman laser according to claim 1, wherein output from the silicon Raman laser is in the mid-infrared part of the spectrum.

3. A silicon Raman laser according to claim 1, wherein output of the silicon Raman laser is controlled by injecting current into said silicon gain medium or said cavity resonator.

4. A silicon Raman laser according to claim 1, wherein the silicon Raman laser is fabricated on a single chip.

5. A silicon Raman laser according to claim 1, further comprising:
means for electrical switching or modulation of the silicon Raman laser.

6. A silicon Raman laser according to claim 1, further comprising:
means for active mode locking of the silicon Raman laser.

7. A silicon Raman laser according to claim 1, further comprising:
means to tune the pump laser;
wherein output from the silicon Raman laser is dependent on adjustment of said means to tune the pump laser.

8. A monolithic silicon Raman laser comprising an on-chip cavity.

9. A silicon Raman laser according to claim 8, wherein said on-chip cavity has a nested cavity configuration.

10. A silicon Raman laser, comprising:
a silicon gain medium; and
a cavity proximate said silicon gain medium;
wherein said cavity has a nested cavity configuration; and
wherein said cavity has multiple resonance frequencies that match multiple Stokes orders of Raman scattering.

11. A silicon Raman laser according to claim 10, wherein output from the silicon Raman laser is in the mid-infrared part of the spectrum.

12. A silicon Raman laser according to claim 10, wherein output form the silicon Raman laser is controlled by injecting current into said silicon gain medium or said cavity resonator.

13. A silicon Raman laser according to claim 10, wherein the silicon Raman laser is fabricated on a single chip.

14. A silicon Raman laser according to claim 10, further comprising:
means for electrical switching or modulation.

15. A silicon Raman laser according to claim 10, further comprising:
means for active mode locking of the silicon Raman laser.

16. A silicon Raman laser according to claim 10, further comprising:
means to couple said silicon gain medium to a pump laser; and
means to tune the pump laser;
wherein output from the silicon Raman laser is dependent on adjustment of said means to tune the pump laser.

17. A silicon Raman laser that simultaneously produces outputs at Stokes and anti-Stokes wavelengths.

18. A process for fabricating a silicon Raman laser, comprising:
providing a silicon gain medium; and
forming a cavity resonator proximate said silicon gain medium.

19. A silicon Raman laser fabricated by the process of claim 18.

20. A silicon Raman laser according to claim 1, 8, 10, or 19, wherein said laser is a functional component of a device from the group consisting of: biochemical sensor systems, infrared countermeasures systems, or free space optical communications systems.

21. A silicon Raman laser according to claim 1, 8, 10, or 19, wherein said laser is a functional component of a medical, dental, or industrial device that exploits the strong laser-tissue interaction at a wavelength of 2.9 microns.
